(19) United States
(12) Patent Application Publication
(10) Pub. No.: US 2026/0364566 A1
(43) Pub. Date: Nov. 19, 2026

(54) CARBON DIOXIDE ADSORBING MATERIAL AND METHOD FOR PRODUCING THE SAME

(71) Applicant: Murata Manufacturing Co., Ltd., Nagaokakyo-shi (JP)

(72) Inventors: Hayata YAMADA, Nagaokakyo-shi (JP); Hideaki Ooe, Nagaokakyo-shi (JP); Yasuhiro Murase, Nagaokakyo-shi (JP)

(21) Appl. No.: 19/725,238

(22) Filed: Jun. 30, 2026

Related U.S. Application Data
(63) Continuation of application No. PCT/JP2025/029161, filed on Aug. 20, 2025.

(30) Foreign Application Priority Data
Sep. 24, 2024 (JP) 2024-165251

(51) Int. Cl. B01J 20/26; B01D 53/02; B01J 20/28; B01J 20/30; B01J 20/32

(52) U.S. Cl. CPC B01J 20/262; B01D 53/02; B01J 20/28004; B01J 20/28007; B01J 20/28059; B01J 20/28071; B01J 20/28073; B01J 20/2808; B01J 20/28083; B01J 20/3078; B01J 20/3204; B01J 20/3272; B01D 2253/202; B01D 2257/504

(57) ABSTRACT

A carbon dioxide adsorbing material that includes: a porous material; and an amine compound incorporated in pores of the porous material. The carbon dioxide adsorbing material has a peak pore size of not less than 0.4 nm and less than 10 nm, a peak pore volume of not less than 0.003 cm³/g/nm, and an average pore diameter of not less than 1 nm and not more than 30 nm.

### CROSS REFERENCE TO RELATED APPLICATIONS

The present application is a continuation of International application No. PCT/JP2025/029161, filed Aug. 20, 2025, which claims priority to Japanese Patent Application No. 2024-165251, filed Sep. 24, 2024, the entire contents of each of which are incorporated herein by reference.

### TECHNICAL FIELD

The present disclosure relates to a carbon dioxide adsorbing material and a method for producing the same.

### BACKGROUND ART

Attempts have been made to recover carbon dioxide gas using adsorbing materials. A known adsorbing material includes a porous or non-porous support and a polyamine that fills or coats the support (Patent Document 1 and Non-Patent Document 1).
Patent Document 1: Japanese Unexamined Patent Application Publication (Translation of PCT Application) No. 2019-507674
Non-Patent Document 1: Applied Surface Science, 332 (2015), 167-171, Chao Chen et al., “Polyethylenimine-incorporated zeolite 13× with mesoporosity for post-combustion CO₂ capture”

### SUMMARY OF THE DISCLOSURE

However, the inventors of the present disclosure have found that carbon dioxide adsorbing materials according to the related art, which adsorb carbon dioxide using polyamines, suffer from a low adsorption rate, which poses a problem. In carbon dioxide adsorption, increasing the adsorption rate is important for improving air quality in a closed room containing a high concentration of carbon dioxide from human respiration.

For example, an adsorbing material including a non-porous support 201 and a polyamine 202 coated on the support 201 has a structure as shown in FIG. 13 and has a limited surface area, and therefore cannot achieve a sufficiently high adsorption rate.

The use of a porous support as disclosed in Patent Document 1 and Non-Patent Document 1 has not yet achieved a sufficiently high adsorption rate.

For example, an adsorbing material including a porous support 301 and a polyamine 302 filling the support 301 has a structure as shown in FIG. 14, and still has a limited surface area. The limited surface area may result in a failure to achieve a sufficiently high adsorption rate. In particular, although the support 301 has porosity and therefore has a large surface area itself, the polyamine 302 fills the pores as shown in FIG. 15, and thus a contactable region 3020 of the polyamine with carbon dioxide 310 is not sufficiently expanded. Accordingly, it will be difficult for carbon dioxide to diffuse into the pores, and the amount of adsorbed carbon dioxide will not increase sufficiently, for example, in the initial stage of adsorption (30 minutes or 60 minutes).

An object of the present disclosure is to provide a carbon dioxide adsorbing material having a sufficiently higher carbon dioxide adsorption rate.

The present disclosure relates to a carbon dioxide adsorbing material including: a porous material; and an amine compound incorporated in pores of the porous material. The carbon dioxide adsorbing material has a peak pore size of not less than 0.4 nm and less than 10 nm, a peak pore volume of not less than 0.003 cm³/g/nm, and an average pore diameter of not less than 1 nm and not more than 30 nm.

The present disclosure also relates to a method for producing a carbon dioxide adsorbing material. The method includes: adding an organic solvent solution of an amine compound to a porous material, mixing the solution and the porous material, and then subjecting the resulting mixture to heat treatment to remove the solvent by degassing.

The carbon dioxide adsorbing material according to the present disclosure exhibits a higher adsorption rate. In the carbon dioxide adsorbing material according to the present disclosure, the porous material has a sufficiently large surface area and, in addition, the amine compound exists in the pores of the porous material without “filling” the pores while ensuring a particular pore size and pore volume. Therefore, carbon dioxide can easily diffuse into the pores. Accordingly, the probability of contact between the amine compound and carbon dioxide is relatively high. This may explain the sufficiently high adsorption rate of the carbon dioxide adsorbing material according to the present disclosure.

### BRIEF DESCRIPTION OF THE DRAWINGS

FIG. 1 is a schematic sectional view illustrating an example of a structure of a carbon dioxide adsorbing material according to the present disclosure.

FIG. 2 is a schematic sectional view illustrating a mechanism by which the adsorption rate of the carbon dioxide adsorbing material according to the present disclosure is improved.

FIG. 3 is a pore size-pore volume graph showing examples of the pore size distributions of carbon dioxide adsorbing materials according to the present disclosure and a carbon dioxide adsorbing material of the related art.

FIG. 4 is an elapsed time-carbon dioxide adsorbed amount graph showing examples of the amount of carbon dioxide adsorbed in the initial stage of adsorption (30 minutes) for the carbon dioxide adsorbing materials according to the present disclosure and the carbon dioxide adsorbing material of the related art shown in FIG. 3.

FIG. 5 is a BET total pore volume of porous material-optimal PEI amount graph showing the optimal PEI amount in production of a carbon dioxide adsorbing material according to the present disclosure.

FIG. 6 is a pore size-pore volume graph showing the pore size distributions of the carbon dioxide adsorbing materials produced in Experimental Example A.

FIG. 7 is an elapsed time-carbon dioxide adsorbed amount graph showing the amount of carbon dioxide adsorbed in the initial stage of adsorption (30 minutes) for the carbon dioxide adsorbing materials produced in Experimental Example A.

FIG. 8 is a PEI solution supplied amount-carbon dioxide adsorbed amount graph showing the amount of carbon dioxide adsorbed in the initial stage of adsorption (60 minutes) for the carbon dioxide adsorbing materials produced in Experimental Example B.

FIG. 9A is a pore size-pore volume graph showing the pore size distributions of the carbon dioxide adsorbing materials produced in Experimental Example B (Examples B1 and B2 and Comparative Examples B1 and B2).

FIG. 9B is a pore size-pore volume graph showing the pore size distributions of the carbon dioxide adsorbing materials produced in Experimental Example B (Example B1 and Comparative Example B3).

FIG. 10 is a pore size-pore volume graph created in Experimental Example C, showing the pore size distribution of the carbon dioxide adsorbing material of Example B1 and the pore size distribution of the porous material only.

FIG. 11 is a pore size-pore volume graph created in Experimental Example C, showing the pore size distribution of the carbon dioxide adsorbing material of Example B2 and the pore size distribution of the porous material only.

FIG. 12 is an elapsed time-carbon dioxide adsorbed amount graph created in Experimental Example D, showing examples of the amount of carbon dioxide adsorbed in the initial stage of adsorption (60 minutes) for the carbon dioxide adsorbing materials of Example A1 and Comparative Example D1.

FIG. 13 is a schematic sectional view illustrating an example of the structure of a carbon dioxide adsorbing material according to the related art.

FIG. 14 is a schematic sectional view illustrating an example of the structure of another carbon dioxide adsorbing material according to the related art.

FIG. 15 is a schematic sectional view illustrating a mechanism by which the adsorption rate of the carbon dioxide adsorbing material of FIG. 14 is not improved sufficiently.

### DESCRIPTION OF THE PREFERRED EMBODIMENTS

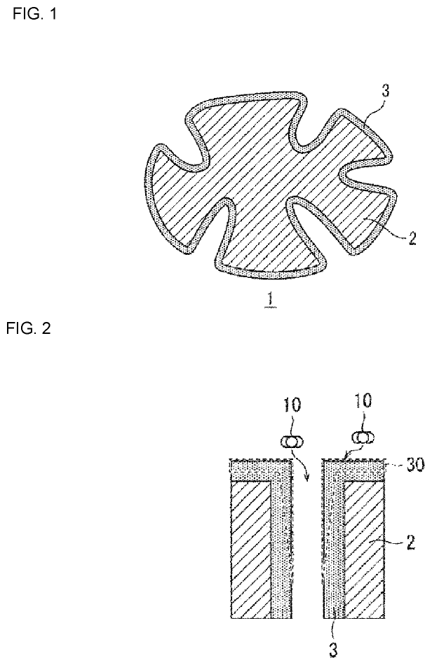

The present disclosure provides a carbon dioxide adsorbing material. The carbon dioxide adsorbing material of the present disclosure includes a porous material and an amine compound. In particular, for example, as shown in FIG. 1, in a carbon dioxide adsorbing material 1 according to the present disclosure, an amine compound 3 is incorporated in the pores of a porous material 2. As used herein, “incorporated” differs from “filled,” which implies that the amine compound completely fills the pores, and “incorporated” means that the amine compound coats the inner walls of the pores as shown in FIG. 1 and, for example, exists in the pores to such an extent that the pore size (and pore volume) described later is ensured. As shown in FIG. 1, the amine compound 3 usually exists not only in the pores of the porous material 2 but also in non-porous regions (or on the outer surface) of the porous material 2, thus covering the entire surface of the porous material 2. FIG. 1 is a schematic sectional view illustrating an example of the structure of the carbon dioxide adsorbing material of the present disclosure. As used herein directly or indirectly, the terms “up-down direction”, “lateral direction”, and “thickness direction” respectively correspond to the up-down direction, lateral direction, and thickness direction in the drawings unless otherwise specified. The same reference numerals or symbols denote the same elements or the same matters unless otherwise specified, and shapes thereof may differ.

The carbon dioxide adsorbing material 1 of the present disclosure incorporates the amine compound 3 in the pores of the porous material 2, and has a pore size larger than the size of a CO₂ molecule. This allows CO₂ to diffuse deep into the pores in a short period of time and can increase the number of effective adsorption sites for carbon dioxide. For example, a contactable region 30 of the amine compound 3 with carbon dioxide 10 is sufficiently expanded as shown in FIG. 2 and, in addition, the pores incorporating the amine compound are nanometer-sized. The number (density) of pores can therefore be increased. Accordingly, the number of effective adsorption sites for carbon dioxide can be increased, and the adsorption rate of carbon dioxide can be sufficiently enhanced. If the amine compound completely “fills” the pores, the number of effective adsorption sites for carbon dioxide cannot be increased, and thus the adsorption rate cannot be enhanced sufficiently. FIG. 2 is a schematic sectional view illustrating a mechanism by which the adsorption rate of the carbon dioxide adsorbing material of the present disclosure is improved.

The pore size of the carbon dioxide adsorbing material of the present disclosure is not less than 0.4 nm and less than 10 nm, and from the viewpoint of further improving the adsorption rate, is preferably not less than 0.4 nm and not more than 5 nm, more preferably not less than 0.4 nm and not more than 2.5 nm, even more preferably not less than 0.5 nm and not more than 1.5 nm, still more preferably not less than 0.5 nm and not more than 1.0 nm, and yet more preferably not less than 0.6 nm and not more than 0.9 nm. When the carbon dioxide adsorbing material of the present disclosure has such a pore size, it can contribute to increasing the amount of carbon dioxide adsorbed. If the pore size is too small or too large, the adsorption rate decreases.

The pore volume of the carbon dioxide adsorbing material of the present disclosure is generally not less than 0.003 cm³/g/nm, and from the viewpoint of further improving the adsorption rate, is preferably not less than 0.003 cm³/g/nm and not more than 0.1 cm³/g/nm, more preferably not less than 0.004 cm³/g/nm and not more than 0.05 cm³/g/nm, even more preferably not less than 0.005 cm³/g/nm and not more than 0.04 cm³/g/nm, still more preferably not less than 0.006 cm³/g/nm and not more than 0.03 cm³/g/nm, yet more preferably not less than 0.007 cm³/g/nm and not more than 0.02 cm³/g/nm, and particularly preferably not less than 0.008 cm³/g/nm and not more than 0.014 cm³/g/nm. When the carbon dioxide adsorbing material of the present disclosure has such a pore volume, it can contribute to increasing the amount of carbon dioxide adsorbed (particularly the adsorption rate). If the pore volume is too small, it cannot contribute to increasing the amount of carbon dioxide adsorbed (particularly the adsorption rate). For example, pores having a too-small pore volume do not contribute to increasing the amount of carbon dioxide adsorbed (particularly the adsorption rate).

The pore size and pore volume of a carbon dioxide adsorbing material herein refer to values based on the maximum peak in a pore size distribution graph, with pore size on the abscissa and pore volume on the ordinate, measured by applying the HK method and the BJH method to a nitrogen adsorption isotherm. Accordingly, the carbon dioxide adsorbing material of the present disclosure has pores having a particular pore size in an amount equal to or greater than a certain level, whereby the adsorption rate can be sufficiently increased. As described above, the “pore size” and “pore volume” of a carbon dioxide adsorbing material are values based on the maximum peak in a pore size distribution graph, and therefore, they may be referred to as “peak pore size” and “peak pore volume”, respectively.

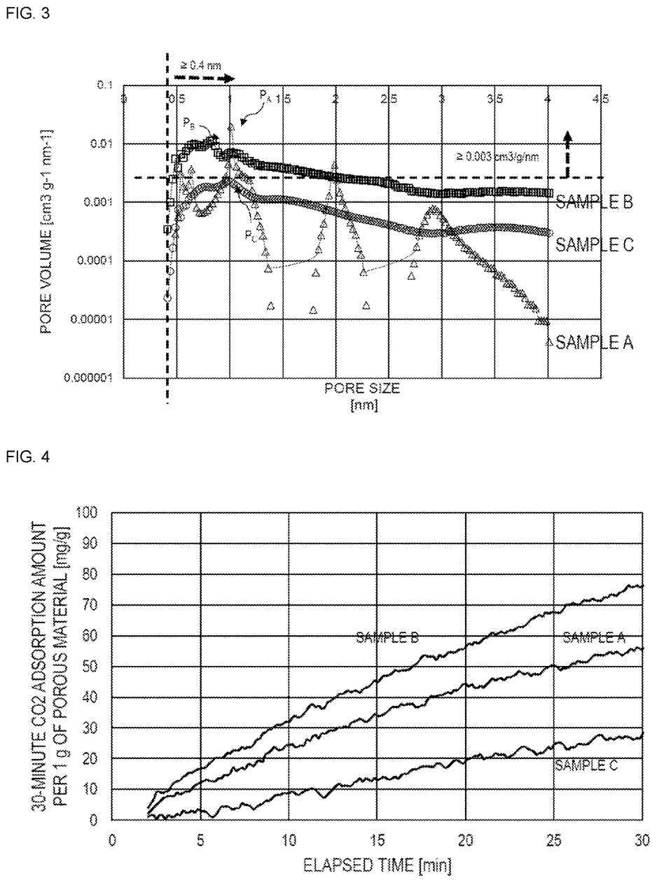

The carbon dioxide adsorbing material of the present disclosure may have, for example, a pore size distribution as shown for sample A or sample B in FIG. 3 in a pore size distribution with pore size on the abscissa and pore volume on the ordinate. For example, in FIG. 3, the pore size distributions of sample A and sample B have maximum peaks PA and PB located within the above-described ranges of pore size and pore volume. In contrast, in the pore size distribution of sample C, the maximum peak Pc is not located within the above-described ranges of pore size and pore volume. Thus, sample C falls outside the scope of the present disclosure. Samples A to C correspond to Examples A1 and B1 and Comparative Example B1, respectively, which will be described later. Accordingly, as shown in FIG. 4, samples A and B within the scope of the present disclosure exhibit sufficiently high carbon dioxide adsorption rates, whereas sample C outside the scope of the present disclosure does not exhibit a sufficiently high carbon dioxide adsorption rate. FIG. 3 is a pore size-pore volume graph showing examples of the pore size distributions of the carbon dioxide adsorbing materials of the present disclosure and the carbon dioxide adsorbing material of the related art. FIG. 4 is an elapsed time-carbon dioxide adsorbed amount graph showing examples of the amount of carbon dioxide adsorbed in the initial stage of adsorption (30 minutes) for the carbon dioxide adsorbing materials of the present disclosure and the carbon dioxide adsorbing material of the related art shown in FIG. 3.

A pore size distribution for measuring the pore size and pore volume of a carbon dioxide adsorbing material can be measured with a gas adsorption measuring device (Belsorp Max X, MicrotracBEL Corp.) using the adsorbing material from which moisture and carbon dioxide have been removed without removing an amine compound. For example, moisture and carbon dioxide can be removed without removing the amine compound by heating and degassing the adsorbing material at 120 °C for 24 hours under atmospheric conditions, and then holding the adsorbing material at 120 °C under vacuum for 15 hours.

The average pore diameter of the carbon dioxide adsorbing material of the present disclosure is not less than 1 nm and not more than 30 nm, and from the viewpoint of further improving the adsorption rate, is preferably not less than 3 nm and not more than 25 nm, more preferably not less than 5 nm and not more than 25 nm, even more preferably not less than 10 nm and not more than 25 nm, still more preferably not less than 15 nm and not more than 25 nm, and particularly preferably not less than 20 nm and not more than 25 nm. If the average pore diameter is too small or too large, the adsorption rate decreases.

The average pore diameter of a carbon dioxide adsorbing material herein refers to a value obtained by measuring the pore size distribution of the adsorbing material in the same manner as described above, and determining the average pore diameter for all the pores.

The total pore volume of the carbon dioxide adsorbing material of the present disclosure is generally not less than 0.005 cm³/g and not more than 1 cm³/g, and from the viewpoint of further improving the adsorption rate, is preferably not less than 0.008 cm³/g and not more than 0.8 cm³/g, more preferably not less than 0.01 cm³/g and not more than 0.7 cm³/g, even more preferably not less than 0.01 cm³/g and not more than 0.6 cm³/g, and still more preferably not less than 0.01 cm³/g and not more than 0.5 cm³/g.

The total pore volume of a carbon dioxide adsorbing material herein refers to a value obtained by measuring the pore size distribution of the adsorbing material in the same manner as described above, and determining the total pore volume for all the pores.

The BET specific surface area of the carbon dioxide adsorbing material of the present disclosure is generally not less than 1 m²/g and not more than 40 m²/g, and from the viewpoint of further improving the adsorption rate, is preferably not less than 2 m²/g and not more than 30 m²/g, more preferably not less than 3 m²/g and not more than 30 m²/g, and even more preferably not less than 10 m²/g and not more than 20 m²/g.

The BET specific surface area of a carbon dioxide adsorbing material herein refers to a value measured by the following method.

A sample is heated and degassed at 120 °C for 24 hours under atmospheric conditions, and then held at 120 °C under vacuum for 15 hours. Thereafter, a nitrogen adsorption isotherm is measured, and the BET equation is applied to the isotherm.

The porous material is not particularly limited as long as it has a large number of pores and can ensure the above-described pore size and pore volume when an amine compound is incorporated in the pores. Examples of the porous material include metal-organic frameworks (MOFs), silica (particularly mesoporous silica and fumed silica), zeolite, calcium sulfate, alumina, titania, activated carbon, and diatomaceous earth. From the viewpoint of further improving the adsorption rate, the porous material is preferably an MOF, silica (particularly mesoporous silica), or zeolite, more preferably an MOF or silica (particularly mesoporous silica), and even more preferably silica (particularly mesoporous silica).

Mesoporous silica is silica having a large number of pores. Mesoporous silica is available as a commercial product. Examples of commercial products of mesoporous silica include MCM-41 (manufactured by Sigma-Aldrich, mesostructure, type (hexagonal)) and MCM-48 (manufactured by Sigma-Aldrich, mesostructure).

An MOF is a porous material based on a coordination bond between an organic molecule and a metal atom. In particular, an MOF is a crystalline complex formed by bridging metal atoms (particularly metal ions) with organic molecules as ligands.

The organic molecules constituting the MOF may be any organic molecules known in the field of MOFs as organic molecules capable of constituting an MOF. From the viewpoint of further improving the adsorption rate, the organic molecules preferably include one or more organic molecules selected from the group consisting of azole-based organic molecules, cyano-based organic molecules, and carboxylic acid-based organic molecules. From the same viewpoint, the organic molecules more preferably include one or more organic molecules selected from the group consisting of azole-based organic molecules and cyano-based organic molecules, and even more preferably include one or more organic molecules selected from the group consisting of azole-based organic molecules. Azole-based organic molecules (particularly imidazole-based organic molecules) are bonded to metal atoms via nitrogen atoms, and therefore exhibit a higher carbon dioxide adsorption rate.

The azole-based organic molecules constituting the MOF include organic molecules selected from the group consisting of imidazole, benzimidazole, triazole, and purine. From the viewpoint of further improving the adsorption rate, imidazole, benzimidazole, and purine are preferred, imidazole and benzimidazole are more preferred, and imidazole is even more preferred.

The azole-based organic molecules may or may not have a substituent.

Examples of the substituent that the azole-based organic molecules may have include one or more substituents selected from the group consisting of hydrophobic groups such as an alkyl group, a halogen atom, a nitro group, a phenyl group, a pyridyl group, and a cyano group; and hydrophilic groups such as an amino group and a carboxyl group.

The alkyl group is, for example, an alkyl group having 1 to 5 carbon atoms (particularly 1 to 3 carbon atoms). Specific examples of the alkyl group include a methyl group, an ethyl group, an n-propyl group, an isopropyl group, an n-butyl group, an isobutyl group, a sec-butyl group, a tert-butyl group, and an n-pentyl group.

Examples of the halogen atom include a fluorine atom, a chlorine atom, and a bromine atom.

From the viewpoint of further improving the adsorption rate, the azole-based organic molecules constituting the MOF are preferably selected from the group consisting of azole-based organic molecules having no substituent and azole-based organic molecules having only a hydrophobic group (particularly an alkyl group or a nitro group) as a substituent, if the azole-based organic molecules have a substituent, and more preferably selected from the group consisting of azole-based organic molecules having only a hydrophobic group (particularly an alkyl group).

Examples of the azole-based organic molecules constituting the MOF include imidazole-based molecules represented by the following general formula (1), benzimidazole-based molecules represented by the following general formula (2), triazole-based molecules represented by the following general formulae (3) and (4), and purine-based molecules represented by the following general formula (5).

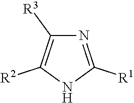

In formula (1), R¹ to R³ are each independently a hydrogen atom; a hydrophobic group such as an alkyl group, a halogen atom, a nitro group, a phenyl group, a pyridyl group, or a cyano group; or a hydrophilic group such as an amino group or a carboxyl group. From the viewpoint of further improving the adsorption rate, a hydrogen atom or the above-described hydrophobic group is preferred, and a hydrogen atom, an alkyl group, a halogen atom, a nitro group, or a cyano group is more preferred. In a more preferred embodiment from the same viewpoint, R¹ is a hydrogen atom, an alkyl group, or a nitro group, and R² and R³ are each a hydrogen atom, an alkyl group, a halogen atom, or a nitro group. In an even more preferred embodiment from the same viewpoint, R¹ is an alkyl group, and R² and R³ are hydrogen atoms.

Specific examples of the imidazole-based molecules represented by general formula (1) include the following compounds: imidazole, methylimidazole (particularly 2-methylimidazole), ethylimidazole, nitroimidazole, aminoimidazole, chloroimidazole, bromoimidazole, and imidazolecarbonitrile.

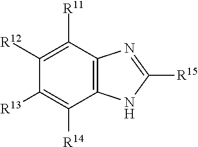

In formula (2), R¹¹ to R¹⁵ are each independently a hydrogen atom; a hydrophobic group such as an alkyl group, a halogen atom, a nitro group, a phenyl group, a pyridyl group, or a cyano group; or a hydrophilic group such as an amino group or a carboxyl group. From the viewpoint of further improving the adsorption rate, a hydrogen atom or the above-described hydrophobic group is preferred, and a hydrogen atom, an alkyl group, a halogen atom, a nitro group, or a cyano group is more preferred. In a more preferred embodiment from the same viewpoint, R¹¹, R¹⁴, and R¹⁵ are hydrogen atoms, and R¹² and R¹³ are each independently a hydrogen atom, an alkyl group, a halogen atom, or a nitro group.

Specific examples of the benzimidazole-based molecules represented by general formula (2) include the following compounds: benzimidazole, chlorobenzimidazole, dichlorobenzimidazole, methylbenzimidazole, bromobenzimidazole, nitrobenzimidazole, aminobenzimidazole, and benzimidazolecarbonitrile.

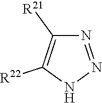

In formula (3), R²¹ and R²² are each independently a hydrogen atom; a hydrophobic group such as an alkyl group, a halogen atom, a nitro group, a phenyl group, a pyridyl group, or a cyano group; or a hydrophilic group such as an amino group or a carboxyl group. From the viewpoint of further improving the adsorption rate, a hydrogen atom or the above-described hydrophobic group is preferred, and a hydrogen atom is more preferred.

Specific examples of the triazole-based molecules represented by general formula (3) include the following compound: 1,2,3-triazole.

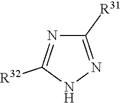

In formula (4), R³¹ and R³² are each independently a hydrogen atom; a hydrophobic group such as an alkyl group, a halogen atom, a nitro group, a phenyl group, a pyridyl group, or a cyano group; or a hydrophilic group such as an amino group or a carboxyl group. From the viewpoint of further improving the adsorption rate, a hydrogen atom or the above-described hydrophobic group is preferred, and a hydrogen atom is more preferred.

Specific examples of the triazole-based molecules represented by general formula (4) include the following compound: 1,2,4-triazole.

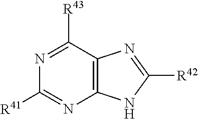

In formula (5), R⁴¹ to R⁴³ are each independently a hydrogen atom; a hydrophobic group such as an alkyl group, a halogen atom, a nitro group, a phenyl group, a pyridyl group, or a cyano group; or a hydrophilic group such as an amino group or a carboxyl group. From the viewpoint of further improving the adsorption rate, a hydrogen atom or the above-described hydrophobic group is preferred, and a hydrogen atom is more preferred.

Specific examples of the purine-based molecules represented by general formula (5) include the following compound: purine.

Potassium ferricyanide, potassium ferrocyanide, or hydrocyanic acid, for example, can be used as the cyano-based organic molecules.

Terephthalic acid, benzenetricarboxylic acid, benzenedicarboxylic acid, or the like can be used as the carboxylic acid-based organic molecules.

The metal atoms constituting the MOF are, for example, selected from the group consisting of zinc atoms, copper atoms, nickel atoms, iron atoms, indium atoms, aluminum atoms, cobalt atoms, praseodymium atoms, cadmium atoms, mercury atoms, and manganese atoms. From the viewpoint of further improving the adsorption rate, the metal atoms are preferably selected from the group consisting of zinc atoms, cobalt atoms, and iron atoms, more preferably from the group consisting of zinc atoms and cobalt atoms, and even more preferably are zinc atoms. A compound for supplying such metal atoms is not particularly limited, and examples thereof include zinc nitrate, copper nitrate, aluminum nitrate, and nickel nitrate.

The combination of an organic molecule and a metal atom in the MOF is not particularly limited. However, from the viewpoint of further improving the adsorption rate, the following combinations (C1) to (C3) are preferred, and the following combination (C1) is more preferred:
combination (C1)=a combination of an imidazole-based molecule represented by general formula (1) (in particular, 2-methylimidazole and/or nitroimidazole) and one or more metal atoms selected from the group consisting of a zinc atom and an iron atom (in particular, a zinc atom);
combination (C2)=a combination of an imidazole-based molecule represented by general formula (1) (in particular, 2-methylimidazole and/or nitroimidazole) and one or more metal atoms selected from the group consisting of a zinc atom and a cobalt atom (in particular, a zinc atom); and
combination (C3)=a combination of a benzimidazole-based molecule represented by general formula (2) and one or more metal atoms selected from the group consisting of a zinc atom and a cobalt atom.

The ratio between organic molecules and metal atoms in the MOF is not particularly limited, and is generally determined by the types of the organic molecules and the metal atoms constituting the MOF.

For example, an MOF containing only an imidazole-based molecule (Im) (e.g., an imidazole-based molecule represented by general formula (1)) and one or more divalent metal atoms (M¹) selected from the group consisting of a zinc atom, a cobalt atom, and an iron atom can be represented by the compositional formula: M¹(Im)₂.

For example, an MOF containing only a benzimidazole-based molecule (bIm) (e.g., a benzimidazole-based molecule represented by general formula (2)) and one or more divalent metal atoms (M¹) selected from the group consisting of a zinc atom, a cobalt atom, and an iron atom can be represented by the compositional formula: M¹(bIm)₂.

For example, an MOF containing only a triazole-based molecule (Tra) (e.g., a triazole-based molecule represented by general formula (3) and/or (4)) and one or more divalent metal atoms (M¹) selected from the group consisting of a zinc atom, a cobalt atom, and an iron atom can be represented by the compositional formula: M¹(Tra)₂.

For example, an MOF containing only a purine-based molecule (Pur) (e.g., a purine-based molecule represented by general formula (5)) and one or more divalent metal atoms (M¹) selected from the group consisting of a zinc atom, a cobalt atom, and an iron atom can be represented by the compositional formula: M¹(Pur)₂.

For example, an MOF containing only an imidazole-based molecule (Im) (e.g., an imidazole-based molecule represented by general formula (1)), a benzimidazole-based molecule (bIm) (e.g., a benzimidazole-based molecule represented by general formula (2)), and one or more divalent metal atoms (M¹) selected from the group consisting of a zinc atom, a cobalt atom, and an iron atom can be represented by the compositional formula: M¹(Im)ₓ(bIm)_{y} (where x+y=2).

The pore size of the MOF depends on the types of organic molecules and metal atoms constituting the MOF. Therefore, the pore size can be adjusted by selecting the types of organic molecules and metal atoms.

The MOF may be, for example, one of the following MOFs:
ZIF-1 (compositional formula: Zn(Im)₂);
ZIF-4 (compositional formula: Zn(Im)₂);
ZIF-7 (compositional formula: Zn(bIm)₂);
ZIF-8 (compositional formula: Zn(mIm)₂);
ZIF-9 (compositional formula: Co(bIm)₂);
ZIF-14 (compositional formula: Zn(eIm)₂);
ZIF-81 (compositional formula: Zn(cbIm)(nIm));
ZIF-75 (compositional formula: Co(mbIm)(nIm));
ZIF-77 (compositional formula: Zn(nIm)₂); and
ZIF-81 (compositional formula: Zn(brbIm)(nIm)).

The abbreviations in the compositional formulae represent the following compounds:

Im: imidazole, bIm: benzimidazole, mIm: methylimidazole, eIm: ethylimidazole, nIm: nitroimidazole, cbIm: chlorobenzimidazole, brbIm: bromobenzimidazole.

The BET specific surface area of the porous material is generally not less than 100 m²/g and not more than 2000 m²/g, and from the viewpoint of further improving the adsorption rate, is preferably not less than 800 m²/g and not more than 1800 m²/g, more preferably not less than 950 m²/g and not more than 1600 m²/g, even more preferably not less than 950 m²/g and not more than 1500 m²/g, and particularly preferably not less than 950 m²/g and not more than 1300 m²/g.

The BET specific surface area of the porous material herein refers to a value measured by the same method as the method for measuring the BET specific surface area of a carbon dioxide adsorbing material.

The average primary particle size of the porous material is generally not less than 0.01 μm and not more than 10 μm, and from the viewpoint of further improving the adsorption rate, is preferably not less than 0.01 μm and not more than 5 μm, more preferably not less than 0.01 μm and not more than 3 μm, and even more preferably not less than 0.02 μm and not more than 0.2 μm.

The average primary particle size herein refers to a median diameter obtained from a particle size distribution, which is determined by circular approximation of 50 randomly selected support particles in an SEM image.

The average pore diameter of the porous material is generally not less than 0.1 nm and not more than 30 nm, and from the viewpoint of further improving the adsorption rate, is preferably not less than 0.2 nm and not more than 20 nm, more preferably not less than 0.2 nm and not more than 10 nm, even more preferably not less than 0.3 nm and not more than 8 nm, and still more preferably not less than 1 nm and not more than 5 nm.

The average pore diameter of the porous material herein refers to a value measured by the same method as the method for measuring the average pore diameter of a carbon dioxide adsorbing material.

The total pore volume of the porous material is generally not less than 0.01 cm³/g and not more than 10 cm³/g, and from the viewpoint of further improving the adsorption rate, is preferably not less than 0.1 cm³/g and not more than 8 cm³/g, more preferably not less than 0.2 cm³/g and not more than 6 cm³/g, even more preferably not less than 0.4 cm³/g and not more than 5 cm³/g, and still more preferably not less than 1 cm³/g and not more than 4 cm³/g.

The total pore volume of the porous material herein refers to a value measured by the same method as the method for measuring the total pore volume of a carbon dioxide adsorbing material.

The amine compound is not particularly limited as long as it is a substance having an amino group, and an amino group-containing organic compound is generally used. The weight-average molecular weight of the amino group-containing organic substance is not particularly limited and may be, for example, 100 or more. From the viewpoint of preventing a decrease in carbon dioxide gas adsorption capacity due to volatilization, the weight-average molecular weight of the amino group-containing organic substance is 300 or more, preferably 500 or more. The upper limit of the weight-average molecular weight is not particularly limited, and the weight-average molecular weight may generally be 10000 or less, particularly 1000 or less. Specific examples of the amino group-containing polymer include polyethyleneimine (PEI), polyamidoamine, and polyvinylamine. The amino group-containing polymer may be linear or branched, and is preferably branched from the viewpoint of further improving the carbon dioxide gas adsorption capacity.

From the viewpoint of further improving the adsorption rate, the amine compound is preferably polyethyleneimine, particularly branched polyethyleneimine.

The amine value of the amine compound (particularly the amino group-containing polymer) is not particularly limited, and it is generally 15 to 25 mmol/g·solid, and from the viewpoint of further improving the adsorption rate, is preferably 17 to 22 mmol/g·solid.

The amine value herein refers to a value measured by a neutralization method that calculates the value based on the amount of hydrochloric acid required to neutralize the amine compound.

In the carbon dioxide adsorbing material of the present disclosure, the content of the amine compound is generally not less than 10 parts by mass and not more than 300 parts by mass based on 100 parts by mass of the porous material. From the viewpoint of further improving the adsorption rate, the content is preferably not less than 30 parts by mass and not more than 300 parts by mass, more preferably not less than 30 parts by mass and not more than 230 parts by mass, even more preferably not less than 50 parts by mass and not more than 220 parts by mass, and still more preferably not less than 100 parts by mass and not more than 220 parts by mass.

The content of the amine compound can be measured and calculated from the masses of the carbon dioxide adsorbing material of the present disclosure before and after removing the amine compound from the adsorbing material. The removal of the amine compound can be easily achieved by washing the carbon dioxide adsorbing material with an organic solvent. The organic solvent is not particularly limited as long as it can dissolve the amine compound. Examples include ethanol, methanol, and chloroform.

In the carbon dioxide adsorbing material of the present disclosure, the pore size at the pore size distribution peak is generally smaller than the pore size at the pore size distribution peak of the porous material not incorporating the amine compound by not less than 0.05 nm and not more than 5 nm. In particular, when the pore size at the pore size distribution peak of the carbon dioxide adsorbing material is represented by r_{A} and the pore size at the pore size distribution peak of the porous material not incorporating the amine compound is represented by r_{B}, the value represented by “r_{B}−r_{A}” is not less than 0.05 nm and not more than 5 nm. From the viewpoint of further improving the adsorption rate, the value is preferably not less than 0.08 nm and not more than 4 nm, more preferably not less than 0.5 nm and not more than 4 nm, and even more preferably not less than 1 nm and not more than 4 nm. The pore size at the pore size distribution peak of the porous material not incorporating the amine compound may be the pore size at the pore size distribution peak of the porous material after the amine compound is removed from the carbon dioxide adsorbing material. The pore size distribution peak refers to the maximum peak in the pore size distribution.

The carbon dioxide adsorbing material of the present disclosure can be produced by the following method:
an organic solvent solution of an amine compound is added to a porous material and mixed therewith, and the resulting mixture is subjected to heat treatment to remove the organic solvent by degassing.

The organic solvent is not particularly limited as long as it can dissolve the amine compound. Examples include ethanol, methanol, and chloroform. If water is used instead of the organic solvent, even when the amine compound dissolves in water, the amine compound cannot be sufficiently incorporated into the pores due to, for example, the surface tension of water. Therefore, the average pore diameter of the carbon dioxide adsorbing material does not increase, and the carbon dioxide adsorbing material of the present disclosure cannot be obtained.

The concentration of the amine compound in the organic solvent solution is generally not less than 10 vol % and not more than 30 vol %, and from the viewpoint of further improving the adsorption rate, is preferably not less than 15 vol % and not more than 25 vol %. In particular, when the amine compound is PEI having an average molecular weight of 600, if the concentration is too high, the pore size and/or pore volume of the resulting carbon dioxide adsorbing material decreases, and the carbon dioxide adsorbing material of the present disclosure cannot be obtained.

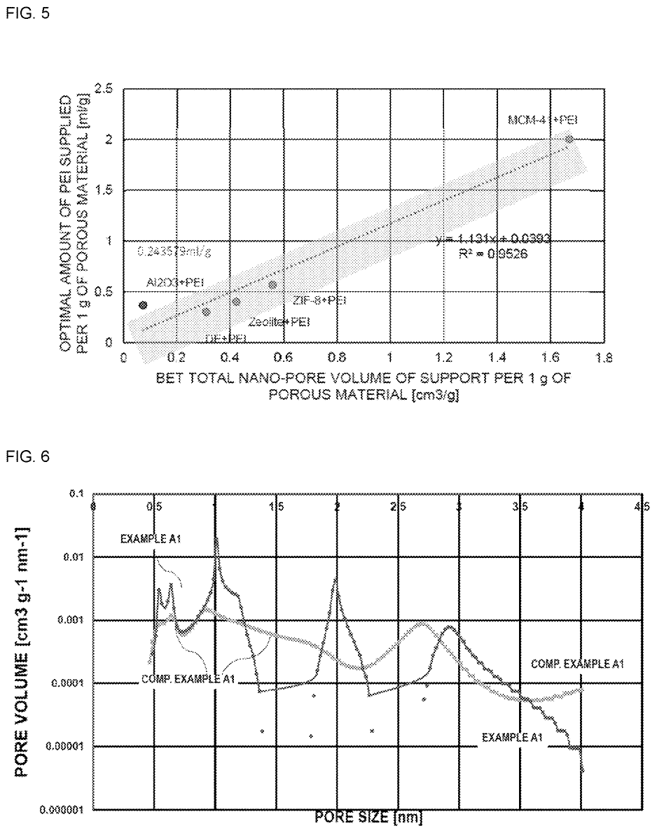

When the BET total pore volume of the porous material is represented by x (cm³/g), the amount y (ml/g) of the amine compound used is within the range of +0.2436 ml/g based on y=1.131x+0.0393 as shown in FIG. 5. In other words, when the BET total pore volume of the porous material is represented by x (cm³/g), the amount of the amine compound used (or supplied) is within the range of (1.131×x−0.2043) to (1.131×x+0.2829) ml/g. The amount of the amine compound used (or supplied) refers to the amount of the amine compound itself. When, for example, the amine compound is used in the form of a solution having a concentration of 200 mg/mL, the amount of the amine compound itself used (or supplied) can be calculated from the amount of the solution added. If the amount of the amine compound used is too large, the pore size and/or pore volume of the resulting carbon dioxide adsorbing material decreases, and the carbon dioxide adsorbing material of the present disclosure cannot be obtained. If the amount of the amine compound used is too small, the absolute amount of amino groups, which serve as carbon dioxide adsorption sites, will be insufficient, and thus, the carbon dioxide adsorbing material of the present disclosure cannot be obtained. FIG. 5 is a BET total pore volume of porous material-optimal PEI amount graph showing the optimal PEI amount in the production of the carbon dioxide adsorbing material of the present disclosure.

The heat treatment is performed under relatively mild conditions. This is considered to slow down the solvent degassing rate, allowing the amine compound solution in a low-viscosity state to diffuse deep into the pores, so that the amine compound is uniformly incorporated in the pores. For example, pure PEI has a very high viscosity, and therefore diffuses more easily into the pores in the presence of a solvent. The heating temperature is not less than 40 °C and not more than 65 °C, and from the viewpoint of further improving the adsorption rate, is preferably not less than 50 °C and not more than 65 °C, more preferably not less than 55 °C and not more than 65 °C. The heating time is not less than 20 minutes and not more than 120 minutes, and from the viewpoint of further improving the adsorption rate, is preferably not less than 40 minutes and not more than 100 minutes, more preferably not less than 50 minutes and not more than 70 minutes. If the heat treatment is performed under severe conditions (strong conditions), the amine compound solution does not diffuse deep into the pores, so that the pore size and/or pore volume of the resulting carbon dioxide adsorbing material decreases, and the carbon dioxide adsorbing material of the present disclosure cannot be obtained.

### (Application)

The carbon dioxide adsorbing material of the present disclosure is characterized by its regenerability at relatively low temperatures (60 °C or higher) and its high carbon dioxide adsorption rate. Therefore, it is expected to be used for DAC (Direct Air Capture), which selectively recovers carbon dioxide from an environment with a low carbon dioxide concentration (particularly the atmosphere).

The present disclosure will now be described in greater detail based on specific examples. It should be noted that the present disclosure is not limited to the following examples.

### EXAMPLES

### Porous Material

Porous materials having the physical property values shown in Table 1 were used.

TABLE 1

| | BET | | BET | Average |
|---|---|---|---|---|
| | specific | BET | average | primary |
| | surface | total pore | pore | particle |
| | area | volume | diameter | size |
| Porous material only | [m²/g] | [cm³/g] | [nm] | [μm] |
| HS-320 | 904 | 0.4239 | 0.9375 | 0.32 |
| (Synthetic zeolite) | | | | |
| ZIF-8 | 1395 | 0.5599 | 0.8024 | 0.24 |
| (MOF) | | | | |
| MCM-41 | 1022 | 1.6702 | 3.269 | 0.07 |
| (Mesoporous silica) | | | | |
| De: Diatomaceous | 116 | 0.3106 | 5.3493 | 1.8 |
| Earth | | | | |
| (Wakkanai origin) | | | | |
| Al₂O₃ | 8 | 0.074083 | 18.529 | 0.19 |

### Experimental Example A

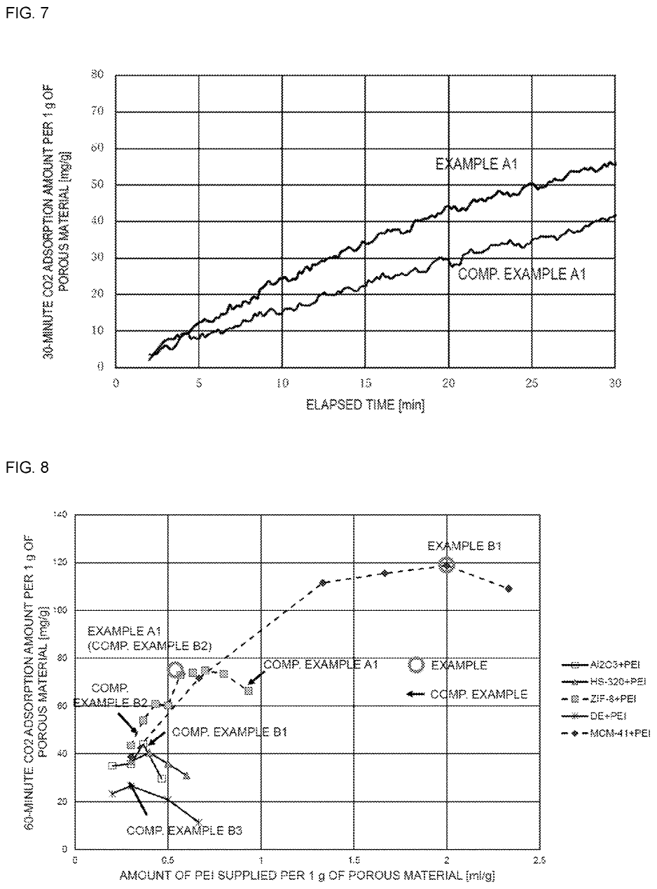

A carbon dioxide adsorbing material obtained by filling a porous material “ZIF-8” with a polyamine (Comparative Example A1), and a carbon dioxide adsorbing material obtained by incorporating a polyamine into the porous material while retaining pores (Example A1) were produced. Their pore size distributions and initial (30-minute) CO₂ adsorption amounts were measured and are shown in FIGS. 6 and 7. The details are as follows.

### Example A1

300 mg of ZIF-8 (Basolite Z1200, manufactured by BASF (sigmaaldrich.com), BET specific surface area: 1395 m²/g) was prepared as a porous material. Thereafter, an ethanol solution containing 20 vol % of polyamine (polyethyleneimine (PEI), average molecular weight=600, amine value=20 mmol/g·solid, manufactured by FUJIFILM Wako Pure Chemical Corporation) was added to the porous material. The amount of the PEI solution (20 vol %) added was 2.83 ml per gram of the porous material (the net amount of PEI added was 0.57 ml per gram of the porous material). After mixing them at 25 °C for 10 minutes under atmospheric pressure, the mixture was heated and degassed at 60 °C for 60 minutes to obtain a carbon dioxide adsorbing material.

### Comparative Example A1

A carbon dioxide adsorbing material was obtained in the same manner as in Example A1, except that the amount of the PEI solution (20 vol %) added was changed to 4.67 ml per gram of the porous material (the net amount of PEI added was 0.93 ml per gram of the porous material).

### (Pore Size Distribution)

A pore size distribution was measured using a gas adsorption measuring device (Belsorp Max X, MicrotracBEL Corp.). In particular, a sample (e.g., a carbon dioxide adsorbing material) was pretreated by heating and degassing it at 120 °C for 24 hours under atmospheric conditions, and then holding it at 120 °C under vacuum for 15 hours. The HK method and the BJH method were applied to the nitrogen adsorption isotherm obtained to measure the pore size distribution as shown in FIG. 6.

In the subsequent experimental examples, when this measurement method was applied to a sample without polyamine incorporation, the pore size distribution was measured in the same manner as described above, except that the pretreatment was performed by holding the sample at 150 °C under vacuum for 15 hours.

### (CO₂ Adsorption Amount in 30 Minutes)

The wet powdery carbon dioxide adsorbing material produced was placed in a 12 L acrylic chamber, and 24 ml of CO₂ gas was introduced into the chamber. The CO₂ concentration was monitored to prepare the graph shown in FIG. 7. The chamber conditions were atmospheric pressure, 25 °C, and approximately 50% humidity.

As can be seen in FIG. 7, the initial (30-minute) CO₂ adsorption amount in Example A1 was approximately 1.4 times higher than that in Comparative Example A1. This indicates that, when it is desired to increase the initial CO₂ adsorption amount, retaining pores without filling them, as in the present disclosure, is preferable to filling the pores as in Patent Document 1. The use of the CO₂ adsorbing material having the features of the present disclosure can improve the initial CO₂ adsorption amount.

### Experimental Example B

### Examples B1 and B2 and Comparative Examples B1 to B3

FIG. 8 shows CO₂ adsorption amounts when the amount of polyamine incorporated in the following porous or non-porous material was varied.
ZIF-8 (porous material, BET specific surface area: 1395 m²/g, Basolite Z1200, manufactured by BASF (sigmaaldrich.com))
HS-320 (porous material, BET specific surface area: 904 m²/g, FUJIFILM Wako Chemicals Corp., CAS RN 308081 May 2, synthetic zeolite, Zeolite, powder, sodium Y)
MCM-41 (porous material, BET specific surface area: 1022 m²/g, mesoporous silica, manufactured by Sigma-Aldrich, mesostructure, type (hexagonal))
DE (porous material, BET specific surface area: 116 m²/g, diatomaceous earth (Wakkanai origin), Shizen Sozai Kenkyujo Co., Ltd.)
Al₂O₃ (non-porous material, BET specific surface area: 8 m²/g, manufactured by Sumitomo Chemical Co., Ltd.)

In particular, carbon dioxide adsorbing materials were obtained in the same manner as in Example A1, except that the above porous or non-porous materials were used and the PEI solution (20 vol %) was supplied in predetermined amounts.

Subsequently, the CO₂ adsorption amounts of the thus-produced adsorbing materials were measured in the same manner as in Experimental Example A except that the produced carbon dioxide adsorbing materials were used and the adsorption time was changed to 60 minutes. FIG. 8 was created based on the relationship between the amount of the PEI solution supplied and the 60-minute CO₂ adsorption amount in each sample. FIG. 8 also shows data for Comparative Example A1.

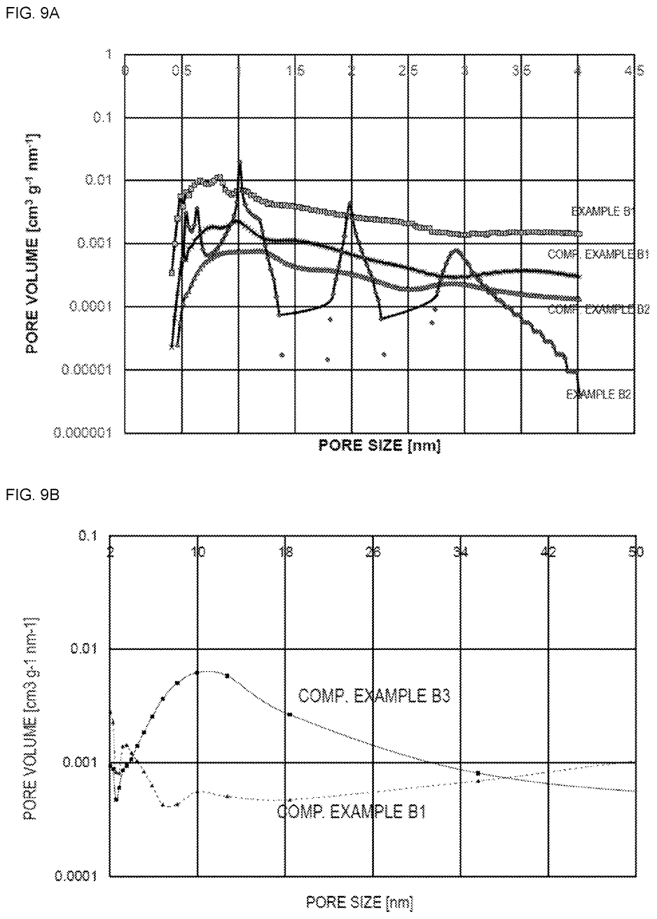

In FIG. 8, the samples indicated by circles were used as Examples B1 and B2 and the samples indicated by arrows were used as Comparative Examples B1, B2, and B3. Their pore size distributions were measured in the same manner as in Experimental Example A and are shown in FIGS. 9A and 9B.

As shown in FIGS. 8, 9A, and 9B, the carbon dioxide adsorbing materials of Examples B1 and B2, having the features of the present disclosure, exhibited a CO₂ adsorption amount that was at maximum approximately 5.3 times larger per 1 g of the porous material compared to the carbon dioxide adsorbing materials of Comparative Examples B1, B2, and B3. Example B2 corresponds to Example A1. In particular, FIG. 9B clearly shows the difference between Example B1 and Comparative Example B3. As can be seen in FIG. 9B, the peak of the pore volume of Comparative Example B3 is at 10 nm. As can be seen in FIG. 8, the CO₂ adsorption amount of Comparative Example B3 is significantly smaller than that of Example B1, indicating that 10-nm pores do not contribute to CO₂ adsorption.

### Experimental Example C

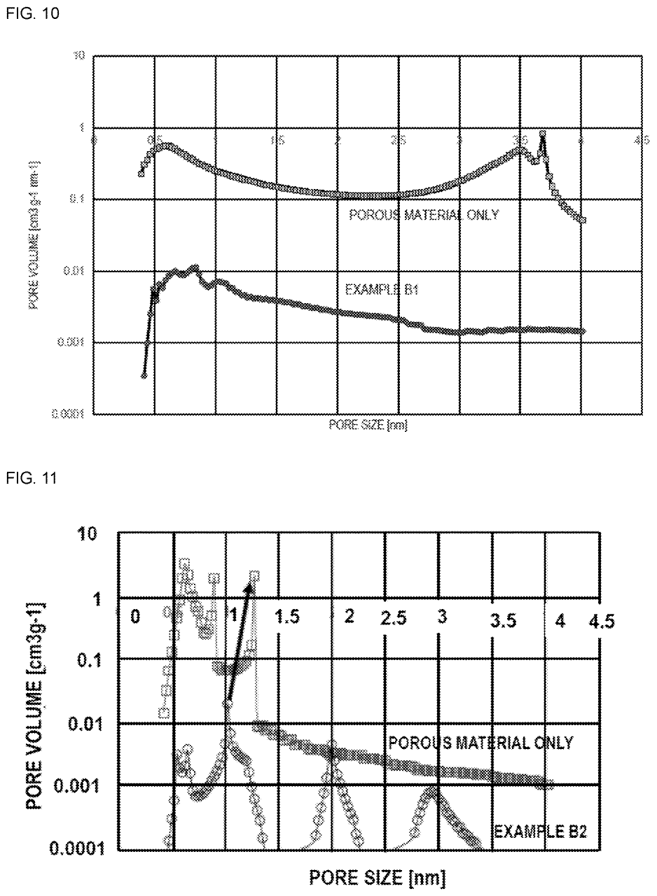

The amine compound (particularly polyamine) was removed from the carbon dioxide adsorbing materials of Examples B1 and B2, which had been produced in Experimental Example B, by thoroughly washing them with ethanol. The resulting porous materials (“porous materials only”) were subjected to pore size distribution measurement using the same method as that in Experimental Example A. The pore size distributions before and after the removal of the amine compound for each of Examples B1 and B2 are shown in FIG. 10 and FIG. 11, respectively.

In FIG. 10, the peaks of the pore size distributions showed a shift of 3 nm.

In FIG. 11, the peaks of the pore size distributions showed a shift of 0.25 nm.

The “shift” herein refers to a value expressed as “r_{B}−r_{A}”, where r_{A} is the pore size at the peak of the pore size distribution of a carbon dioxide adsorbing material, and r_{B} is the pore size at the peak of the pore size distribution of the porous material from which the amine compound has been removed.

The peak shift in such pore size distributions is considered to correspond to a decrease in pore size, which corresponds to twice the thickness of the polyamine in the pores.

### Experimental Example D

### Comparative Example D1

A carbon dioxide adsorbing material was obtained in the same manner as in Example A1, except that water was used instead of ethanol as the solvent for the polyamine solution.

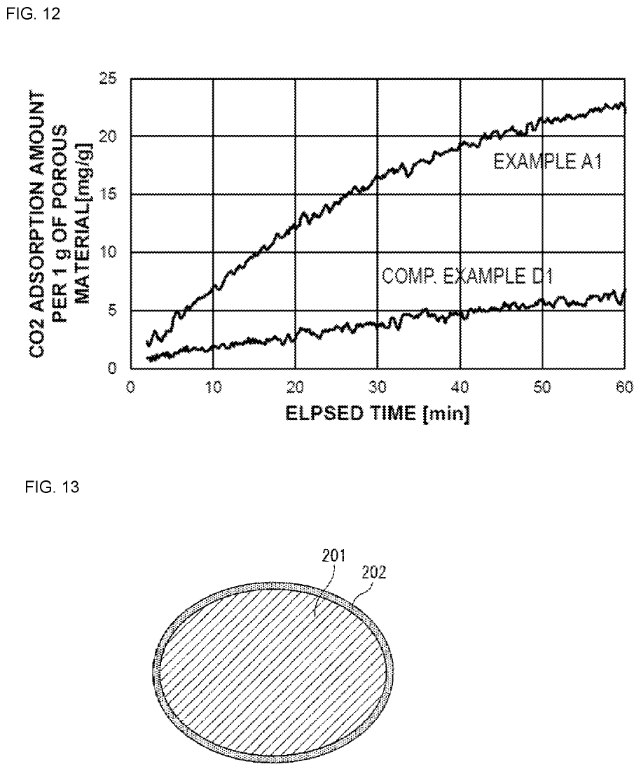

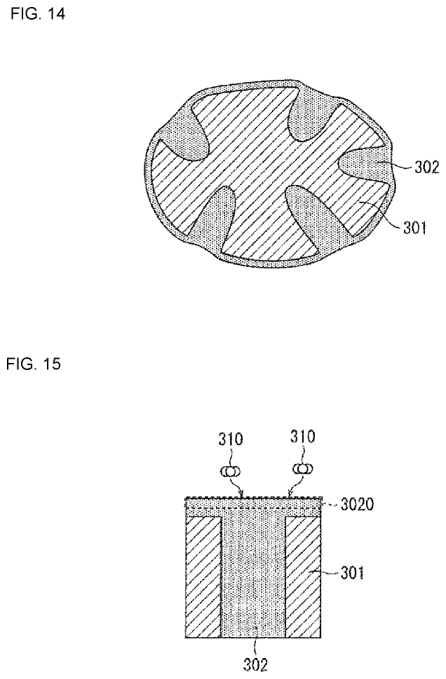

Subsequently, the CO₂ adsorption amount of the thus-produced adsorbing materials was measured in the same manner as in Experimental Example A except that the carbon dioxide adsorbing material produced in Comparative Example D1 was used and the adsorption time was changed to 60 minutes. The results are shown in FIG. 12. The CO₂ adsorption amount of the carbon dioxide adsorbing material produced in Example A1 was also measured, and is shown in FIG. 12. FIG. 12 is an elapsed time-carbon dioxide adsorbed amount graph showing examples of the amount of carbon dioxide adsorbed in the initial stage of adsorption (60 minutes) for the carbon dioxide adsorbing materials of Example A1 and Comparative Example D1.

### <Characteristic Values>

The characteristic values of the carbon dioxide adsorbing materials of Examples A1 (B2) and B1 and Comparative Examples A1, B1, B2, B3, and D1 are shown below.

TABLE 2

| | | | | Content of | | Max. CO₂ | | BET | | BET |
|---|---|---|---|---|---|---|---|---|---|---|
| | | Maximum peak *1 | | amine | | adsorption | Amount | specific | BET | average |
| | | Pore | Pore | compound | | amount in | of PEI | surface | total pore | pore |
| | Sample | size | volume | (parts by | Solvent | 60 min | added | area | volume | diameter |
| | (support + PEI) | [nm] | [cm³/g/nm] | mass) *2 | *3 | [mg] *4 | [ml]*4 | [m²/g] | [cm³/g] | [nm] |
| Example | ZIF-8-PEI | 1.0 | 0.020 | 60 | EtOH | 74.9 | 0.57 | 5.3988 | 0.014908 | 5.5226 |
| A1 | (MOF) | | | | | | | | | |
| (Example | | | | | | | | | | |
| B2) | | | | | | | | | | |
| Example | MCM-41-PEI | 0.8 | 0.011 | 210 | EtOH | 118.7 | 2 | 21.378 | 0.2393 | 22.385 |
| B1 | (mesoporous | | | | | | | | | |
| | silica) | | | | | | | | | |
| Comp. | ZIF-8-PEI | 0.9 | 0.0015 | 98 | EtOH | 66.3 | 0.93 | 2.8187 | 0.012353 | 8.7649 |
| Example | (MOF) | | | | | | | | | |
| A1 | | | | | | | | | | |
| Comp. | HS-320-PEI | 1.0 | 0.0022 | 42 | EtOH | 40.5 | 0.4 | 5.0741 | 0.035495 | 13.991 |
| Example | (synthetic | | | | | | | | | |
| B1 | zeolite) | | | | | | | | | |
| Comp. | Al₂O₃-PEI | 1.2 | 0.0008 | 39 | EtOH | 44.2 | 0.37 | 2.1419 | 0.0071431 | 6.67 |
| Example | | | | | | | | | | |
| B2 | | | | | | | | | | |
| Comp. | DE-PEI | 10 | 0.006 | 32 | EtOH | 26.7 | 0.3 | 31.598 | 0.1429 | 9.044 |
| Example | (Wakkanai | | | | | | | | | |
| B3 | diatomaceous | | | | | | | | | |
| | earth) | | | | | | | | | |
| Comp. | ZIF-8-PEI | 0.6 | 0.8487 | 60 | H2O | 22.2 | 0.57 | 359.81 | 0.1514 | 0.8418 |
| Example | (MOF) | | | | | | | | | |
| D1 *5 | | | | | | | | | | |

*1 Maximum peak in a pore size distribution graph, with pore size on the abscissa and pore volume on the ordinate.
*2 Value based on 100 parts by mass of the porous material.
*3 Solvent used in the amine compound solution.
*4 Value per 1 g of the porous material.
*5 Comparative example using water as a solvent.

As can be seen from a comparison of the values of ZIF-8 and MCM-41 in Table 1 with the values of Examples A1 and B1 in Table 2, the average pore diameter of the carbon dioxide adsorbing material in which the amine compound is incorporated is larger than the average pore diameter of each of the porous materials. This is believed to be due to the following reasons. When PEI is added to the porous material, most small pores (e.g., pores of 1 nm or less) are filled with PEI and thus are not counted, and only larger pores (e.g., pores of 1 nm or more) are counted. For this reason, the average pore diameter of the porous material is apparently larger than the average pore diameter of the carbon dioxide adsorbing material.

As can be seen from a comparison of the values of ZIF-8 and MCM-41 in Table 1 with the values of Examples A1 and B1 in Table 2, the total pore volume of each of the porous materials is larger than the total pore volume of the carbon dioxide adsorbing material in which the amine compound is incorporated. This is believed to be due to the following reasons. When PEI is added to the porous material, pores of the porous material are filled with PEI. For this reason, the total pore volume of the porous material is larger than the total pore volume of the carbon dioxide adsorbing material.

### (CO₂ Adsorption Amount in 60 Minutes)

Measurement was performed in the same manner as in the “CO₂ Adsorption Amount in 30 minutes” described above, except that CO₂ adsorption amount in 60 minutes was measured.

### (Optimal Amount of PEI Supplied)

In FIG. 8, the amount of the PEI solution supplied that achieved the maximum “CO₂ adsorption amount in 60 minutes” is defined as the “optimal amount of PEI supplied”.

### (BET Specific Surface Area)

The BET specific surface area of only the support (porous material or non-porous material) for incorporating polyamine therein was measured using Belsorp Max X (manufactured by MicrotracBEL Corp.).

The measurement conditions were as follows:
Heating and degassing at 120 °C for 24 hours under atmospheric conditions;
Pretreatment (by holding the support) at 150 °C under vacuum for 15 hours;
Measurement of a nitrogen adsorption isotherm in the relative pressure range of 1.0E-8 to 0.99; and
Applying the BET method to the nitrogen adsorption isotherm.

The BET specific surface area of the wet powdery carbon dioxide adsorbing material incorporating polyamine was measured using Belsorp Max X (manufactured by MicrotracBEL Corp.).

The measurement conditions were as follows:

Heating and degassing at 120 °C for 24 hours under atmospheric conditions;

Pretreatment (by holding the carbon dioxide adsorbing material) at 120 °C under vacuum for 15 hours;

Measurement of a nitrogen adsorption isotherm in the relative pressure range of 1.0E-8 to 0.99; and

Applying the BET method to the nitrogen adsorption isotherm.

### (Pore Volume)

The pore size distribution was measured in the same manner as described above, and the BET total pore volume was determined. In particular, the value at a relative pressure of 0.99 was used as the BET total pore volume.

### (Average Pore Diameter)

The pore size distribution was measured in the same manner as described above, and the average pore diameter for all pores was determined.

(Average Primary Particle size)

The average primary particle size refers to a median diameter obtained from a particle size distribution, which was determined by circular approximation of 50 randomly selected support particles (porous material or non-porous material) in an SEM image.

The carbon dioxide adsorbing material of the present disclosure is useful for sensors (particularly carbon dioxide sensors), carbon dioxide gas adsorbing filters, and carbon dioxide gas removal devices.

### REFERENCE SIGNS LIST

1 carbon dioxide adsorbing material
2 porous material
3 amine compound
10 carbon dioxide
30 contactable region of amine compound with carbon dioxide

1. A carbon dioxide adsorbing material comprising:
a porous material; and
an amine compound incorporated in pores of the porous material, wherein
the carbon dioxide adsorbing material has a peak pore size of not less than 0.4 nm and less than 10 nm, a peak pore volume of not less than 0.003 cm³/g/nm, and an average pore diameter of not less than 1 nm and not more than 30 nm.

2. The carbon dioxide adsorbing material according to claim 1, wherein the peak pore size at a pore size distribution peak of the carbon dioxide adsorbing material is smaller than a peak pore size at a pore size distribution peak of the porous material not incorporating the amine compound by not less than 0.05 nm and not more than 5 nm.

3. The carbon dioxide adsorbing material according to claim 1, wherein a content of the amine compound in the carbon dioxide adsorbing material is not less than 10 parts by mass and not more than 300 parts by mass based on 100 parts by mass of the porous material not incorporating the amine compound.

4. The carbon dioxide adsorbing material according to claim 1, wherein the porous material has an average primary particle size of not less than 0.01 μm and not more than 10 μm.

5. The carbon dioxide adsorbing material according to claim 1, wherein the amine compound is an amino group-containing polymer having a weight-average molecular weight of 100 or more.

6. The carbon dioxide adsorbing material according to claim 1, wherein the amine compound is polyethyleneimine.

7. The carbon dioxide adsorbing material of claim 6, wherein the polyethyleneimine is branched polyethyleneimine.

8. The carbon dioxide adsorbing material of claim 1, wherein the porous material is selected from a metal-organic framework, silica, zeolite, calcium sulfate, alumina, titania, activated carbon, or diatomaceous earth.

9. The carbon dioxide adsorbing material of claim 1, wherein the porous material is mesoporous silica.

10. The carbon dioxide adsorbing material of claim 1, wherein the porous material has a BET specific surface area of not less than 100 m²/g and not more than 2000 m²/g.

11. The carbon dioxide adsorbing material of claim 1, wherein the carbon dioxide adsorbing material has a total pore volume of not less than 0.005 cm³/g and not more than 1 cm³/g.

12. The carbon dioxide adsorbing material of claim 1, wherein the carbon dioxide adsorbing material has a BET specific surface area of not less than 1 m²/g and not more than 40 m²/g.

13. A method for producing a carbon dioxide adsorbing material, the method comprising:
adding an organic solvent solution of an amine compound to a porous material and mixing the organic solvent solution with the porous material to form a mixture; and
subjecting the mixture to heat treatment to remove the organic solvent by degassing.

14. The method for producing a carbon dioxide adsorbing material according to claim 13, wherein the heat treatment is performed by heating the mixture at 40 °C to 65 °C for 20 minutes to 120 minutes.

15. The method for producing a carbon dioxide adsorbing material according to claim 13, wherein an amount of the amine compound used is not less than (1.131×x−0.2043) ml/g and not more than (1.131×x+0.2829) ml/g, where x represents a BET total pore volume of the porous material in cm³/g at a relative pressure of 0.99.

16. The method of claim 13, wherein the organic solvent is selected from ethanol, methanol, or chloroform.

17. The method of claim 13, wherein the amine compound is polyethyleneimine.

18. The method of claim 13, wherein the porous material is selected from a metal-organic framework, silica, zeolite, calcium sulfate, alumina, titania, activated carbon, or diatomaceous earth.

19. The method of claim 13, wherein the carbon dioxide adsorbing material produced by the method has a peak pore size of not less than 0.4 nm and less than 10 nm, a peak pore volume of not less than 0.003 cm³/g/nm, and an average pore diameter of not less than 1 nm and not more than 30 nm.

20. A carbon dioxide adsorbing material produced by the method of claim 13.
